(19) United States
(12) Patent Application Publication
(10) Pub. No.: US 2013/0045003 A1
(43) Pub. Date: Feb. 21, 2013

(54) DETECTING THE PRESENCE OF STIMULATED BRILLOUIN SCATTERING IN A FIBER OF A COMMUNICATION SYSTEM

(71) Applicants: Venkatesh G. Mutalik, Middleton, CT (US); Kevin P. Orazietti, Chester, CT (US)

(72) Inventors: Venkatesh G. Mutalik, Middleton, CT (US); Kevin P. Orazietti, Chester, CT (US)

(21) Appl. No.: 13/209,549

(22) Filed: Aug. 15, 2011

(51) Int. Cl. H04B 10/08

(52) U.S. Cl. 398/25

(57) ABSTRACT

Methods and apparatuses are provided to determine whether SBS is present in a fiber of a communication system. An SBS detector comprising a circulator and a detector is used to determine whether SBS is occurring in a fiber. An input optical signal can be received at a first port of the circulator and output at a second port of the circulator where the fiber is connected. The circulator can receive a reflected optical signal from the fiber at the second port of the circulator and output the reflected optical signal at the third port. A detector connected to third port of the circulator receives the reflected optical signal and converts the reflected optical signal to a D.C. voltage.

### TECHNICAL FIELD

This disclosure relates to detecting Stimulated Brillouin Scattering in a fiber of a communication system.

### BACKGROUND

In a communication system, information is transmitted via message signals through a physical medium from a source to a destination. For example, a cable-based system can be used to deliver high-definition digital entertainment and telecommunications such as video, voice, and high-speed Internet services from a headend to subscribers over an existing cable television network. The cable television network can take the form of an all-coax, all-fiber, or hybrid fiber/coax (HFC) network. In an HFC network, for example, an optical transmitter in the headend/hub converts the electrical signals (e.g., data, video, and voice signals) to optical signals. The optical signals are transmitted downstream via a fiber to a fiber node that serves a group of end users (“service group”). The fiber node can include an optical receiver that converts the received optical signals to electrical signals that then are transmitted to the service group, for example, via receiving devices such as cable modems (CMs) and/or settop boxes (STBs).

If the optical power input to a fiber is too high, a phenomenon known as Stimulated Brillouin Scattering (SBS) can occur. With SBS, a portion of the light input to the fiber is reflected and the power level of the light transmitted through the fiber is reduced below the intended input power level, among other deleterious effects. SBS can reduce the quality of the signal output from the fiber and thereby affect the performance of a communication system.

The performance of a communication system, which can be characterized by its carrier to noise ratio (CNR), composite second order (CSO) distortion, composite triple beat (CTB) distortion, among other measurements, can degrade for a variety of reasons including SBS. Traditional methods for determining whether SBS is present in a fiber of a communication system require the use of a spectrum analyzer. For example, to determine whether SBS is present in a fiber of a communication system a technician at the input of the fiber varies the optical power of the light input to the fiber and a second technician at the other end of the fiber analyzes the output signals using a spectrum analyzer. Thus, traditional methods can require multiple technicians and costly equipment. It can be desirable to troubleshoot for SBS in a communication system using less costly means.

### BRIEF DESCRIPTION OF THE DRAWINGS

FIG. 1 is a block diagram illustrating an example communication system.

FIG. 2 is a block diagram illustrating an example SBS detector that can be used to determine whether SBS is present in a fiber of a communication system.

FIG. 3 is a block diagram illustrating the dual use of the SBS detector of FIG. 2 in a communication system.

FIG. 4 is a block diagram illustrating an alternative implementation of an example SBS detector that can be used to determine whether SBS is present in a fiber of a communication system.

FIG. 5 is a block diagram illustrating another implementation of an example SBS detector that can be used to determine whether SBS is present in a fiber of a communication system.

### DETAILED DESCRIPTION

Various implementations of this disclosure use cost effective means to determine whether SBS is present in a fiber of a communication system using a circulator and a detector.

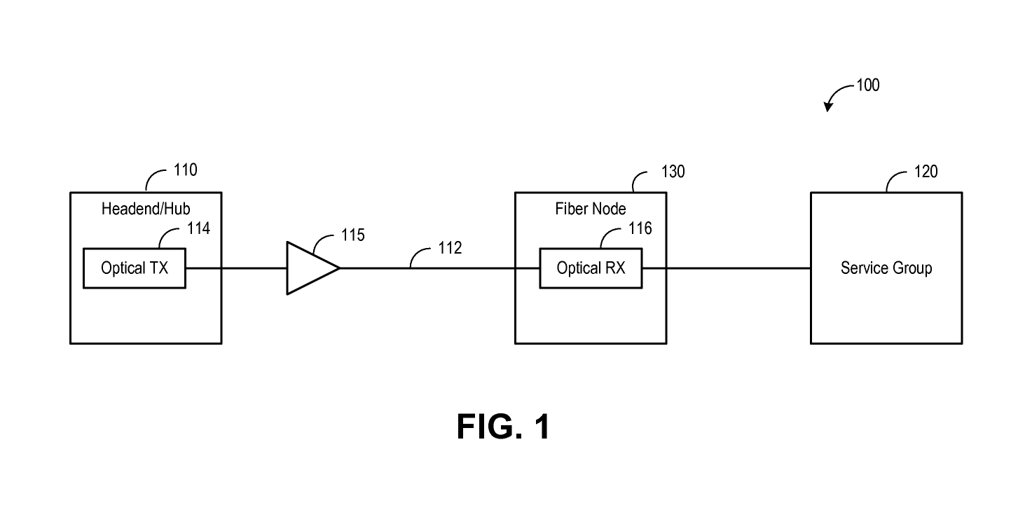

FIG. 1 illustrates an example communication system 100 operable to deliver high-definition digital entertainment and telecommunications such as video, voice, and high-speed Internet services over a fiber 112 between a headend/hub 110 and fiber node 130 for delivery to a service group of receiving devices such as cable modems (CMs) and/or settop boxes (STBs) 120. An optical transmitter 114 in the headend/hub 110 converts electrical signals representing various services (e.g., video, voice, and Internet) to optical signals for transmission over the fiber 112 to the fiber node 130. In some implementations, the optical signal from the transmitter 114 can be amplified by an amplifier 115 (e.g., an erbium doped fiber amplifier (EDFA)) before reaching the fiber node 130. The fiber node 130 includes an optical receiver 116 that converts the received optical signals to electrical signals. The electrical signals then are transmitted to service group 120.

If the optical power of the light input to the fiber 112 is too high, SBS can occur, which can reduce the quality of the signal received at the fiber node 130 and thereby affect the performance of the communication system 100.

As discussed above, traditional methods for determining whether SBS is present in a fiber of a communication system require the use of a spectrum analyzer. For the communication system 100 of FIG. 1, to determine whether SBS is present in the fiber 112 a technician at the input of the fiber 112 (e.g., at the headend/hub 110) varies the optical power of the light input to the fiber and a second technician (e.g., at the fiber node 130) analyzes the output signals using a spectrum analyzer. Thus, traditional methods can require multiple technicians and costly equipment.

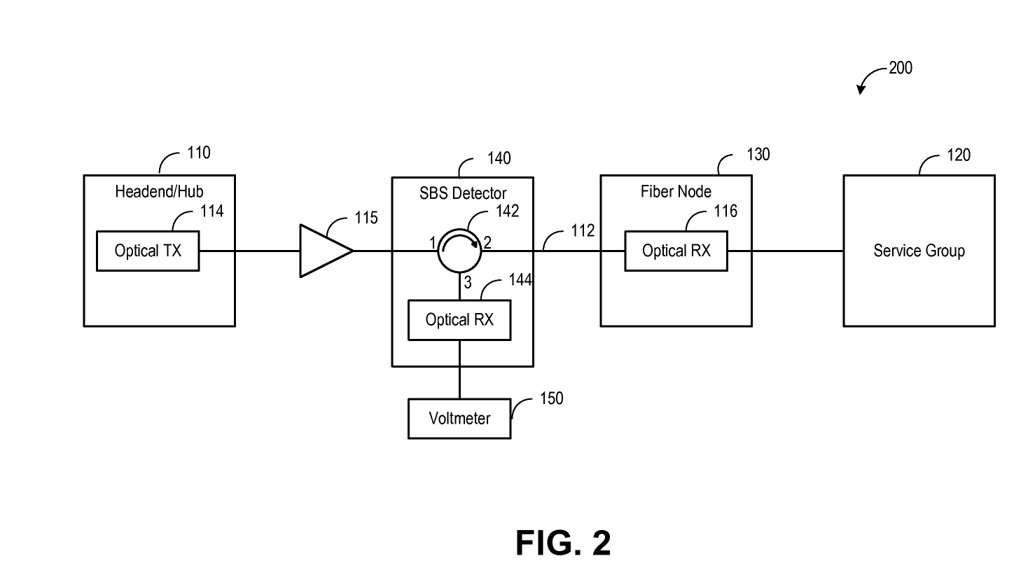

FIG. 2 illustrates an example SBS detector that can be used to determine whether SBS is present in a fiber of a communication system. The SBS detector 140 includes a circulator 142 and an optical receiver 144. Circulator 142 can receive input optical signals at any one of its ports and output the optical signal at the next port in the direction of rotation of the circulator 142. The optical receiver 144 can be a standard optical receiver such as the optical receiver 116 in the fiber node 130.

To determine whether SBS is present in the fiber 112, the output of the optical transmitter 114 can be connected to port 1 of the circulator 142 and the fiber 112 can be connected to port 2 of the circulator 142. In some implementations, the optical signal output from the optical transmitter 114 is first fed through an amplifier 115 prior to being input to port 1 of the circulator 142. The optical receiver 144 can be connected to port 3 of the circulator 142.

In this way, the optical signal output from the optical transmitter 114 or alternatively amplifier 115 will be received at port 1 of the circulator 142, output from port 2 of the circulator 142, and transmitted on the fiber 112. If SBS is present in the fiber 112, a portion of the light input to the fiber 112 from port 2 of the circulator will be reflected from the fiber 112 and will enter port 2 of the circulator 142. The reflected light then will be output from port 3 of the circulator 142. The optical receiver 144 connected to port 3 of the circulator 142 will receive the reflected light. The optical receiver 144 can convert the reflected light to a D.C. voltage. A voltmeter 150 connected to the optical receiver 144 can received the D.C. voltage and display the optical power of the reflected light (“the SBS power”). If the SBS power reading from voltmeter 150 is of a sufficient level, then it can be determined that SBS has occurred and appropriate action can be taken.

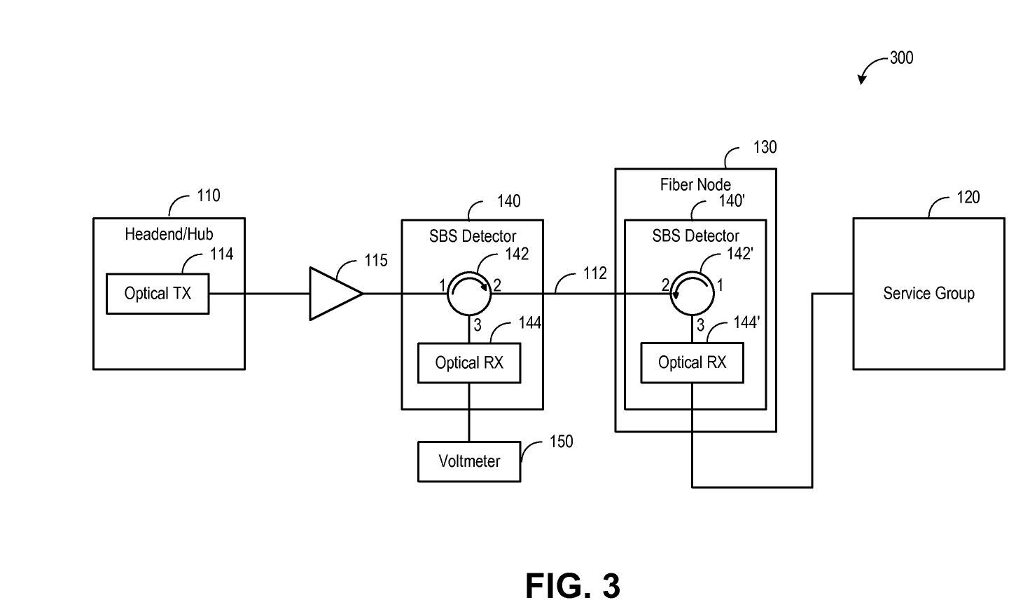

With the SBS detector 140 of FIG. 2, it can be less costly than traditional means to determine whether SBS is occurring in a fiber. Furthermore, the SBS detector 140 of FIG. 2 can have dual uses. The SBS detector 140 can be used to determine whether SBS is presence in a fiber as discussed above; moreover, it can be used as a standard receiver in an optical node as shown in FIG. 3. More specifically, as shown in FIG. 3, in the fiber node 130, the fiber 112 can be connected to port 2 of the circulator 142′. In this way, the optical signal output from the fiber 112 will be received at port 2 of the circulator 142 and output from port 3 of the circulator 142′. The optical receiver 144′ connected to port 3 will receive the optical signal. The optical receiver 144′ can convert the received optical signal to an electrical signal, which then can be transmitted to service group 120.

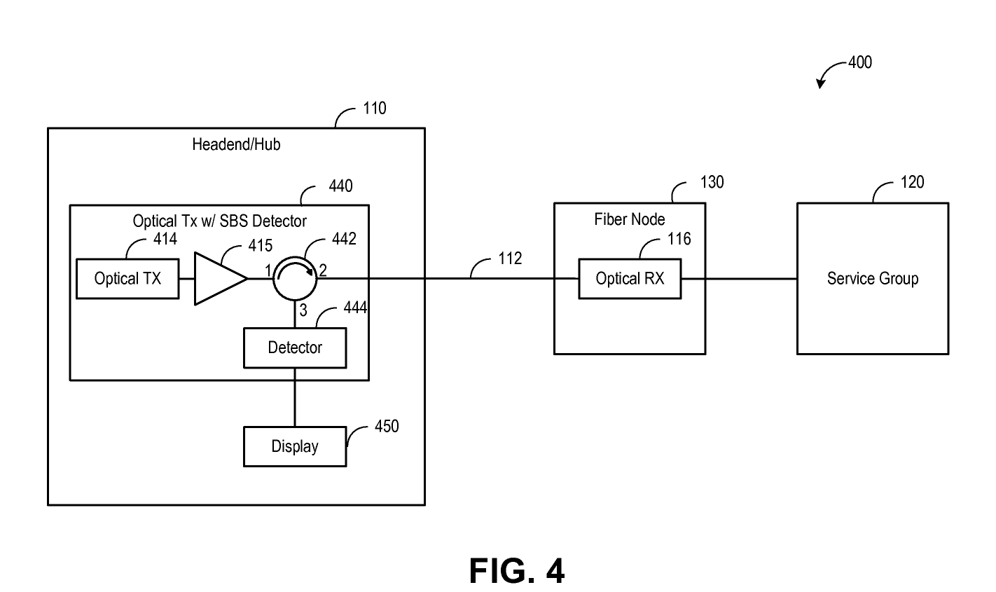

FIG. 4 illustrates an alternative implementation of an example SBS detector that can be used to determine whether SBS is present in a fiber of a communication system. The SBS detector 440 of FIG. 4 includes a transmitter 414, such as transmitter 114, a circulator 442, and a detector 444. In some implementations, the transmitter 114 is a transmitter with SBS suppression capabilities. In some implementation, the optical signal output from the optical transmitter 414 is first fed through an amplifier 415 (e.g., a variable amplifier) prior to being input to port 1 of the circulator 442. The detector 444 can be a standard optical receiver such as the optical receiver 116 or any current or future developed device that can convert any reflected light from fiber 112 to a D.C. voltage to determine the SBS power. In some implementations, the SBS power reading can be displayed on a display 450.

When transmitter 114 is configured for SBS suppression capabilities, the SBS detector 400 can be used to, among other things, verify the ratings of a fiber (e.g., whether the fiber is a standard signal mode fiber).

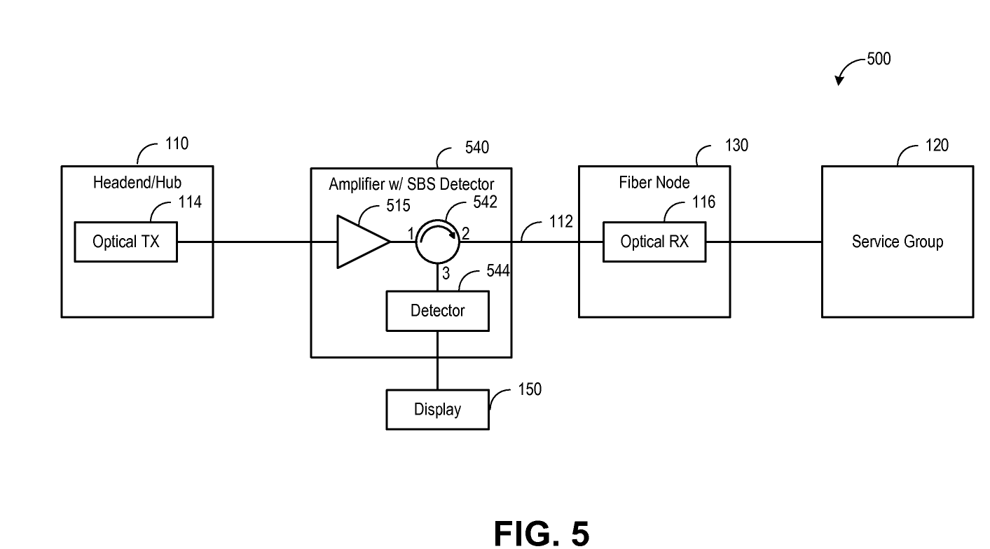

FIG. 5 illustrates yet another implementation of an example SBS detector that can be used to determine whether SBS is present in a fiber of a communication system. The SBS detector 540 of FIG. 5 includes an amplifier 515 (e.g., an EDFA), a circulator 542, and a detector 544, such as the detector 444 of FIG. 4.

By using the SBS detectors 140, 440, and 540 of FIGS. 2, 4, and 5 respectively, it can be less costly than traditional means to determine whether SBS is occurring in a fiber.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that any described program components and systems can generally be integrated together in a single software product or packaged into multiple software products.

Particular implementations of the subject matter described in this specification have been described. Other implementations are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. An apparatus to determine whether SBS is present in a fiber of a communication system, the apparatus comprising:
a circulator comprising at least three ports wherein the circulator is configured to receive an input optical signal at a first port of the circulator and output the input optical signal at a second port of the circulator wherein the second port of the circulator is the next port in the direction of rotation of the circulator after the first port and wherein the circulator is configured to receive a reflected optical signal at the second port of the first circulator from a fiber connected to the second port of the circulator when an input optical signal is received at the first port of the circulator and configured to output the reflected optical signal at a third port of the circulator wherein the third port of the circulator is the next port in the direction of rotation of the circulator after the second port of the circulator; and
a detector connected to a third port of the circulator wherein the detector is configured to measure the reflected optical signal level.

2. The apparatus of claim 1 wherein the detector is an optical receiver.

3. The apparatus of claim 1 wherein the detector is configured to convert the reflected optical signal to a D.C. voltage.

4. The apparatus of claim 3 further comprising a display device connected to the detector and configured to receive the D.C. voltage from the detector and display the optical power of the reflected optical signal.

5. A method for determining whether SBS is present in a fiber of a communication system, the method comprising:
receiving an input optical signal at a first port of a circulator wherein the input optical signal is output at a second port of the circulator wherein the second port of the circulator is the next port in the direction of rotation of the circulator after the first port;
receiving a reflected optical signal at the second port of the circulator wherein the reflected optical signal is from a fiber connected to the second port of the circulator and wherein the reflected optical signal is output at a third port of the circulator wherein the third port of the circulator is the next port in the direction of rotation of the circulator after the second port; and
measuring the reflected optical signal level.

6. The method of claim 5 wherein measuring the reflected optical signal level comprises converting the reflected optical signal to a D.C. voltage.

7. The method of claim 5 further comprising displaying the optical power of the reflected optical signal on a monitor.

8. A communication system comprising:
a first circulator comprising at least three ports wherein the first circulator is configured to receive an input optical signal at a first port of the first circulator and output the input optical signal at a second port of the first circulator wherein the second port of the first circulator is the next port in the direction of rotation of the first circulator after the first port of the first circulator;
a fiber wherein a first end of the fiber is connected to the second port of the first circulator wherein the first circulator is configured to receive a reflected optical signal at the second port of the first circulator from the fiber connected to the second port of the first circulator when an input optical signal is received at the first port of the first circulator and configured to output the reflected optical signal at a third port of the first circulator wherein the third port of the first circulator is the next port in the direction of rotation of the first circulator after the second port of the first circulator;
a first optical receiver connected to the third port of the first circulator wherein the first optical receiver is configured to measure the reflected optical signal level;
a second circulator comprising at least three ports wherein a second end of the fiber is connected to a second port of the second circulator wherein the second port of the second circulator is the next port in the direction of rotation of the second circulator after a first port of the second circulator and wherein the second circulator is configured to receive a transmitted optical signal at the second port of the second circulator from the fiber connected to the second port of the second circulator when the input optical signal is received at the first port of the first circulator and configured to output the transmitted optical signal at a third port of the second circulator wherein the third port of the second circulator is the next port in the direction of rotation of the second circulator after the second port of the second circulator; and
a second optical receiver connected to the third port of the second circulator wherein the second optical receiver is configured to convert the transmitted optical signal to an electrical signal.
